(19) United States
(12) Patent Application Publication
(10) Pub. No.: US 2019/0254132 A1
(43) Pub. Date: Aug. 15, 2019

(54) CONTROL SYSTEM

(71) Applicants: LUCIS TECHNOLOGIES (SHANGHAI) CO., LTD., Shanghai (CN); LUCIS TECHNOLOGIES HOLDINGS LIMITED, Grand Cayman (KY)

(72) Inventor: Qinggang HE, Shanghai (CN)

(73) Assignees: LUCIS TECHNOLOGIES (SHANGHAI) CO., LTD., Shanghai (CN); LUCIS TECHNOLOGIES HOLDINGS LIMITED, Grand Cayman (KY)

(21) Appl. No.: 16/326,705

(22) PCT Filed: Mar. 29, 2017
(86) PCT No.: PCT/CN2017/078510

§ 371 Date: Apr. 16, 2019

(30) Foreign Application Priority Data
Aug. 19, 2016 (CN) PCT/CN2016/096091

(51) Int. Cl. H05B 33/08; H05B 37/02

(52) U.S. Cl. CPC H05B 33/0815; H05B 37/0254; H05B 37/0272

(57) ABSTRACT

The present disclosure discloses a control system. The control system may include a master controller and one or more subordinate controllers. The master controller may include a first switch, a first input port, and a first output port. The first input port may be connected to the first output port, and the first output port may be connected to an electric device. The subordinate controller may be electrically connected to the master controller. The subordinate controller may include a second switch, a third switch, a second input port, and a second output port connected to a hot wire. The third switch may control on/off statuses of the first switch and the second switch. The second switch and the third switch may be connected between the second input port and the second output port. The second switch may be may be connected in parallel with the third switch.

### CROSS-REFERENCE TO RELATED APPLICATIONS

This application claims PCT application No. PCT/CN2016/096091, filed on Aug. 19, 2016, the contents of which are incorporated herein by reference.

### TECHNICAL FIELD

The present disclosure generally relates to a control system, and in particular, to a smart switch.

### BACKGROUND

Household appliances may generally include various household electronic appliances, lighting devices, a video intercom device, and/or a security device. Currently, a traditional switch control system may control the operating states of one or more household appliances. It is desirable to provide a control system for people to control the operating states of the household appliances in real-time.

### SUMMARY

According to an aspect of the present disclosure, a control system may be provided. The system may include a master controller and one or more subordinate controllers. The master controller may include a first switch, a first input port, and a first output port. The first input port may be connected to the first output port, and the first output port may be connected to a device. The subordinate controller may be electrically connected to the master controller. The subordinate controller may include a second switch, a third switch, a second input port, and a second output port connected to a hot wire. The third switch may control on/off statuses of the first switch and the second switch. The first switch may control an operating state of the device and/or the master controller. The second switch and the third switch may be connected between the second input port and the second output port. The second switch may be connected in parallel with the third switch. For example, when the third switch is in a closed state, the second switch may be in a non-operating state, and the first switch may be in an operating state. When the third switch is in a disconnection state, the second switch may be in an operating state, and the first switch may be in a non-operating state.

According to some embodiments of the present disclosure, the first switch may include a thyristor. The thyristor may include a silicon-controlled switch. The second switch may include a thyristor. The thyristor may include a silicon-controlled switch.

According to some embodiments of the present disclosure, the third switch may include an electronic controller. The electronic controller may include a relay switch. The relay switch may be an electromagnetic relay device, a time relay device, a solid state relay device, a magnetic reed relay device, a light relay device, or the like, or any combination thereof.

According to some embodiments of the present disclosure, the system may further include a fourth switch. The fourth switch may be connected in parallel with the first switch.

According to another aspect of the present disclosure, a control system may be provided. The system may include a master switch, a subordinate switch, and an electric device. The subordinate switch may be connected to the master switch. The subordinate switch may obtain electrical power from the master switch. The subordinate switch may obtain data related to an operating state of a device. The subordinate switch may obtain data in an adjacent location of a first location or a second location. The subordinate switch may generate, based at least in part on the data related to the operating state of the device, the data in the adjacent location related to the first location or the second location, an instruction related to the operating state of the device. The data related to the operating state of the device may include an on/off status, an operating power, an operating time, an operating temperature of the device, or the like, or any combination thereof. The data in the adjacent location related to the first location may include environmental parameters of the first location, such as humidity, temperature, or the like. The data in the adjacent location related to the second location may include environmental parameters of the second location, such as humidity, temperature, or the like.

According to another aspect of the present disclosure, a control method may be provided. The method may include obtaining data related to an operating state of a device; obtaining data in an adjacent location related to a first location or a second location; generating, based at least in part on the data related to the operating state of the device, the data in the adjacent location related to the first location or the second location, an instruction related to the operating state of the device. The data related to the operating state of the device may include an on/off status, an operating power, an operating time, an operating temperature of the device, or the like, or any combination thereof. The data in the adjacent location related to the first location may include environmental parameters of the first location, such as humidity, temperature, or the like. The data in the adjacent location related to the second location may include environmental parameters of the second location, such as humidity, temperature, or the like.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The drawings described herein are used to provide a further understanding of the present disclosure, all of which form a part of this specification. It is to be expressly understood, however, that the exemplary embodiment(s) of this disclosure are for the purpose of illustration and description only and are not intended to limit the scope of the present disclosure. Like reference numerals represent similar structures throughout the several views of the drawings, and wherein:

FIG. 1 is a schematic diagram of an exemplary control system according to some embodiments of the present disclosure;

FIG. 2 is a schematic diagram of an exemplary master controller according to some embodiments of the present disclosure;

FIG. 3 is a flowchart of an exemplary process for generating an instruction according to some embodiments of the present disclosure;

FIG. 4 is a schematic diagram of an exemplary subordinate controller according to some embodiments of the present disclosure;

FIG. 5 is a schematic diagram of an exemplary data processing module of a master controller according to some embodiments of the present disclosure;

FIG. 6 is a schematic diagram of an exemplary connection module according to some embodiments of the present disclosure;

FIG. 7 is a schematic diagram of an exemplary connector according to some embodiments of the present disclosure;

FIG. 8 is a schematic diagram of an exemplary connection between a master controller and a subordinate controller according to some embodiments of the present disclosure;

FIG. 9 is a schematic diagram of an exemplary connection between a subordinate controller and another subordinate controller according to some embodiments of the present disclosure;

FIG. 10 is a schematic diagram of an exemplary connector according to some embodiments of the present disclosure;

FIG. 11 is a schematic diagram of an exemplary connection between a master controller and a subordinate controller according to some embodiments of the present disclosure;

FIG. 12 is a flowchart of an exemplary process for generating an instruction for controlling an operating state of a device according to some embodiments of the present disclosure;

FIG. 13 is a schematic diagram of an exemplary connection pattern in a control system according to some embodiments of the present disclosure;

FIG. 14 is a schematic diagram of an exemplary connection pattern in a control system according to some embodiments of the present disclosure; and

FIG. 15 is a schematic diagram of an exemplary connection pattern in a control system according to some embodiments of the present disclosure.

### DETAILED DESCRIPTION

In order to illustrate the technical solutions related to the embodiments of the present disclosure, brief introduction of the drawings referred to in the description of the embodiments is provided below. Obviously, drawings described below are only some illustrations or embodiments of the present disclosure. A person of ordinary skill in the art, without further creative effort, may apply the present teachings to other scenarios according to these drawings. It is to be understood that the terms of the present disclosure are not intended to limit the scope of the present disclosure in any way. Unless stated otherwise or obvious from the context, the same reference numeral in the drawings refers to the same structure and operation.

As used in the disclosure and the appended claims, the singular forms “a,” “an,” and “the” include plural referents unless the content clearly dictates otherwise. In general, the terms “comprise” and “include” merely prompt to include steps and elements that have been clearly identified, and these steps and elements do not constitute an exclusive listing. The methods or devices may also include other steps or elements.

Some modules of the system may be referred to in various ways according to some embodiments of the present disclosure, however, any number of different modules may be used and operated in a client terminal and/or a server. These modules are intended to be illustrative, not intended to limit the scope of the present disclosure. Different modules may be used in different aspects of the system and method.

According to some embodiments of the present disclosure, flow charts are used to illustrate the operations performed by the system. It is to be expressly understood, the operations above or below may or may not be implemented in order. Conversely, the operations may be performed in inverted order, or simultaneously. Besides, one or more other operations may be added to the flow charts, or one or more operations may be omitted from the flow chart.

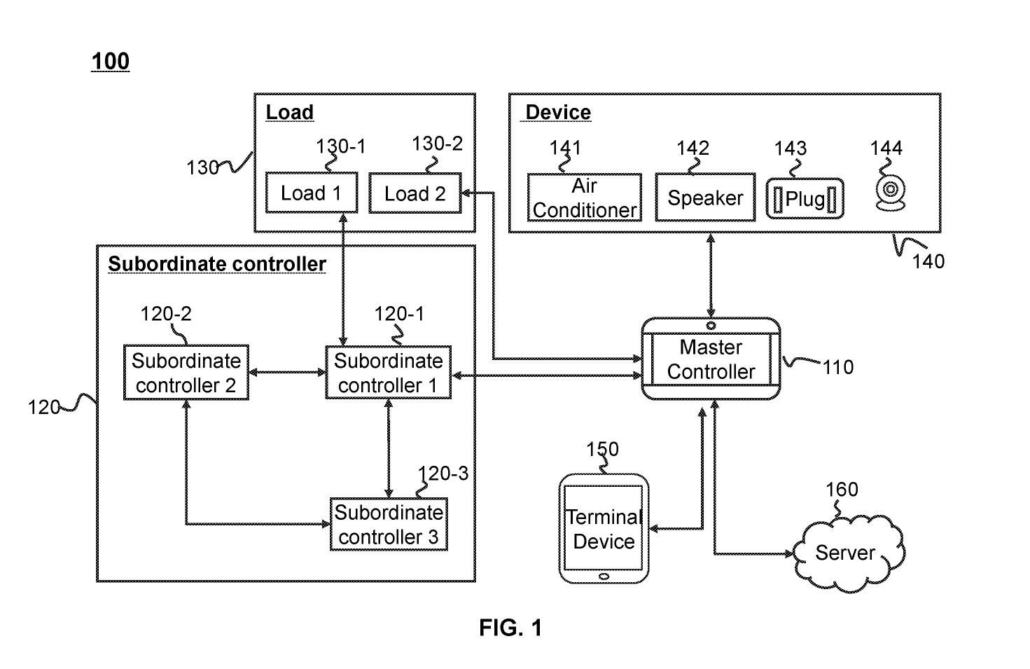

FIG. 1 is a schematic diagram of an exemplary control system 100 according to some embodiments of the present disclosure. The control system 100 may include one or more master controllers 110, a plurality of subordinate controllers 120 (e.g., a subordinate controller 120-1, a subordinate controller 120-2, . . . , a subordinate controller 120-N (not shown)), a plurality of loads 130 (e.g., a load 130-1, a load 130-2, . . . , a load 130-N (not shown)), one or more electric devices 140, a terminal device 150, and a server 160. The one or more electric devices 140 may include an air conditioner 141, a speaker 142, a plug 143, and a security device 144. The control system 100 may control the load 130 and/or the one or more electric devices 140.

A subordinate controller 120 may be selectively connected to the master controller 110 to control a load 130 and/or an electric device 140. In some embodiments, the load 130-1 may be selectively connected to the subordinate controller 120-1. The load 130-2 may be selectively connected to the master controller 110.

In some embodiments, the master controller 110 may be connected to one or more subordinate controllers 120. For example, the master controller 110 may be directly connected to a subordinate controller 120. The master controller 110 may also be indirectly connected to another subordinate controller 120 or another device via the subordinate controller 120. Additionally, a subordinate controller 120 may be connected to one or more other subordinate controllers 120. For example, as shown in FIG. 1, the master controller 110 may be connected to the subordinate controller 120-1. The subordinate controller 120-1 may be connected to the subordinate controller 120-2 and the subordinate controller 120-3. The subordinate controller 120-2 may be connected to the subordinate controller 120-3.

It should be noted that, there may be many different connections between the master controller 110 and the plurality of subordinate controllers 120. In some embodiments, the master controller 110 may be connected to the plurality of subordinate controller 120 successively. For example, the master controller 110 may be connected to the subordinate controller 120-1, the subordinate controller 120-1 may be connected to the subordinate controller 120-2, the subordinate controller 120-2 may be connected to the subordinate controller 120-3, and so on. In some embodiments, the master controller 110 may be connected to multiple subordinate controllers 120, such as the subordinate controller 120-1, the subordinate controller 120-2, the subordinate controller 120-3, . . . , and the subordinate controller 120-N, to form a network-like structure. For example, the subordinate controller 120-1 may be connected to two or more subordinate controllers 120.

The user may communicate with the master controller 110 via the terminal device 150. In some embodiments, the master controller 110 may be connected to a network. The network may include a wireless local area network, a personal network, a metropolitan area network, a wide area network, or the like, or any combination thereof. For example, the network may be a Bluetooth™ network, a Wi-Fi network, a WLAN network, a ZigBee™ network, or the like, or any combination thereof.

The master controller 110 may be placed in a location. In some embodiments, the master controller 110 may be installed on a wall or in a suitable location. For example, the master controller 110 may be installed on the wall of a bedroom. In some embodiments, the master controller 110 may be electrically connected to one or more of the subordinate controller 120-1, the subordinate controller 120-2, . . . , the subordinate controller 120-N, etc. For example, the master controller 110 may be connected to the one or more of the subordinate controller 120-1, the subordinate controller 120-2, . . . , the subordinate controller 120-N, etc., via wired connections. The master controller 110 may obtain information from the load 130, or transmit an instruction to the load 130. The subordinate controllers 120-1 to 120-N may be placed in the same location or in different locations. The subordinate controllers 120-1 to 120-N and the master controller 110 may be placed in the same location or in different locations. For example, if the control system 100 is installed in a user's home, the master controller 110 may be installed on the wall of the bedroom in the user's home, and the subordinate controllers 120-1 to 120-N may be installed in a study room, a bathroom, a hallway, and/or a living room in the user's home, respectively.

A load 130 may be a device that may consume or convert electrical energy into another form of energy. For example, the load 130 may convert electrical energy into other energy such as mechanical energy, internal energy, chemical energy, light energy, radiation energy, or the like. Merely by way of example, the load 130 may be an electric light, an electric motor, an electric heater, etc. The electric light may be an incandescent light, a light emitting diode, a high intensity gas discharge light, a high frequency electrodeless light, a halogen light, or the like, or any combination thereof. The electric motor may be a rotating motor, a signal motor, a control motor, or the like, or any combination thereof. The electric heater may be a device for converting electrical power into thermal energy, for example, a rice cooker, a soldering iron, an electric water heater, or the like, or any combination thereof.

The electric device 140 may include an air conditioner 141, a speaker 142, a plug 143, and a security device 144. In some embodiments, the electric device 140 may be directly connected to the master controller 110. In some embodiments, the electric device 140 may be connected to the master controller 110 via a network, such as a Bluetooth™ network, a Wi-Fi network, a WLAN network, a ZigBee™ network, or the like. For example, a refrigerator connected to the WLAN network may transmit its real-time-measured refrigerator temperature data and energy consumption data to the master controller 110 via the WLAN network. In some embodiments, the air conditioner 141, the speaker 142, and/or the security device 144 may be electrically connected to a smart plug 143, and connected to the master controller 110 via the smart plug 143. In some embodiments, the electrical connections between the air conditioner 141, the speaker 142, and/or the security device 144, and the smart plug 143 may be implemented by wired connections. The smart plug 143 may be connected to a network, such as a local area network, a personal network, a metropolitan area network, and/or a wide area network, through which a remote control of the smart plug 143 may be achieved. In some embodiments, the smart plug 143 may receive or transmit information via the network.

The security device 144 may be used to acquire image information. The image information may be image information of a surrounding environment of the security device 144, or image information of a user. In some embodiments, the security device 144 may include one or more surveillance cameras and/or an alarm. In some embodiments, the security device 144 may monitor the image information of the surrounding environment and transmit a monitored event to the master controller 110. The event may be set by a user or the control system 100. For example, the event may be a person approaching or entering an environment monitored by the security device 144, such as a user's home, a backyard, or other region. In some embodiments, the security device 144 may receive an instruction from the master controller 110, such as opening a door, closing a door, activating an alarm, etc. In some embodiments, the security device 144 may collect image information associated with the user and transmit the image information associated with the user to the terminal device 150. In some embodiments, the user may implement a real-time video communication via the security device 144 and the terminal device 150.

The terminal device 150 may receive, transmit and/or display information. For example, the terminal device 150 may include a user device, such as a smartphone, a tablet computer, a laptop computer, a wearable device, or the like, or any combination thereof. In some embodiments, the terminal device 150 may receive information from the master controller 110. In some embodiments, the user may transmit an instruction to the master controller 110 via the terminal device 150. The instruction may be related to an operating state of a load 130. For example, the user may set parameters of the master controller 110 via the terminal device 150 (e.g., a smartphone) to control the operating state of the electric device 140. As another example, the user may receive operating data associated with the electric device 140 via the terminal device 150 (e.g., a smartphone).

The server 160 may receive and store data obtained from the master controller 110. The data may be related to historical operating data of the loads 130-144, historical operations of the user, and/or operating states of the loads 130-144. In some embodiments, the master controller 110 may receive historical operating data of the loads 130-144 from the server 160. In some embodiments, the server 160 may be a cloud server.

It should be noted that the above description of the control system 100 is merely provided for illustration purposes, and not intended to limit the scope of the present disclosure. For persons having ordinary skills in the art, multiple variations and modifications may be made under the teachings of the present disclosure. Modules may be combined in various ways, or connected with other modules as sub-systems. However, those variations and modifications do not depart from the scope of the present disclosure.

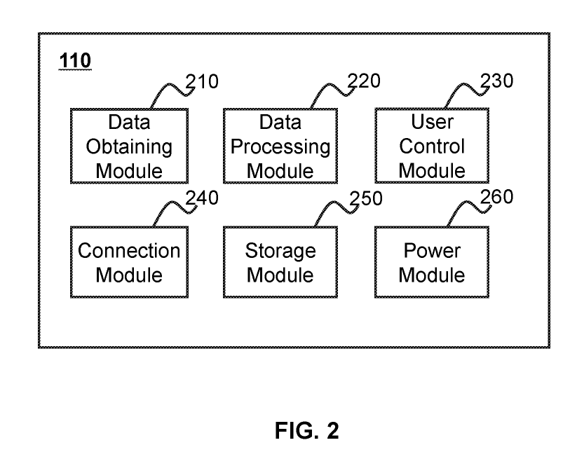

FIG. 2 is a schematic diagram of an exemplary master controller 110 according to some embodiments of the present disclosure. The master controller 110 may include a data obtaining module 210, a data processing module 220, a user control module 230, a connection module 240, a storage module 250, and a power module 260.

The data obtaining module 210 may be connected to the electric device(s) 140, the subordinate controller(s) 120, the data processing module 220, the user control module 230, the connection module 240, and/or the storage module 250. In some embodiments, the data obtaining module 210 may acquire data from one or more of the aforementioned devices or modules. In some embodiments, the data obtaining module 210 may transmit data to one or more of the aforementioned devices or modules. The data may be related to a real-time operating state of the electric device 140, a historical operating state of the electric device 140, and a historical operation of the user. In some embodiments, the data obtaining module 210 may obtain the real-time operating data or the historical operating data of the electric device 140 from the electric device 140 connected to the master controller 110. In some embodiments, the real-time operating data of the electric device 140 may be related to the real-time operating state of the electric device 140. The operating state may include an on/off status, an operating power, an operating time, an operating temperature of electric device 140, or the like, or any combination thereof. In some embodiments, the real-time operating data of the electric device 140 may be collected by the electric device 140 during operating. For example, the security device 144 may be connected to the master controller 110. The data obtaining module 210 may obtain real-time image data acquired by the security device 144. The historical operating data of the electric device 140 may be related to the operating state of the electric device 140 in a certain time slot. The certain time slot may be, for example, one week before the current time, one month before the current time, or the like. In some embodiments, the data obtaining module 210 may obtain the on/off status of the subordinate controller(s) 120 and the load(s) 130 (e.g., the load 130-1) connected to the subordinate controller 120 from a subordinate controller (e.g., subordinate controller 120-1) connected to the master controller 110. For example, the load 130-1 (e.g., a light) may be connected to the subordinate controller 120-1. The subordinate controller 120-1 may be connected to the master controller 110. The data obtaining module 210 may obtain the on/off status, the operating time, the operating power, or the like, of the load 130-1 (e.g., a light) from the subordinate controller 120-1. In some embodiments, the data obtaining module 210 may include a sensor. The sensor may measure environmental parameters, such as humidity, temperature, light intensity, etc., related to the environment in which the master controller is located. The sensor may be or include an infrared sensor, a pressure sensor, a temperature sensor, a humidity sensor, a gas sensor, or the like. According to the operating mechanism principle, the sensor may be a resistive sensor, an inductive sensor, a capacitive sensor, an electric potential sensor, or the like.

The data processing module 220 may process data received from the user control module 230, the load 130, the electric device 140, the data obtaining module 210, the connection module 240, and/or the storage module 250. The data may be related to the operation of the load 130 and/or the electric device 140. In some embodiments, the data processing module 220 may include a processor to perform analysis processing on the received data. In some embodiments, the processed data may be stored in the storage module 250. In some embodiments, the processed data may be transmitted to the load 130, the electric device 140, the terminal device 150, a server, or the like, or any combination thereof, via the connection module 240. The processor may include a central processing unit (CPU), a programmable logic device (PLD), an application special integrated circuit (ASIC), a microprocessor, a system on chip (SoC), a digital signal processor (DSP), or the like. Two or more processors may be integrated into one hardware device. The processor may implement data processing in various ways, for example, via hardware, software, or a combination of the hardware and the software.

The user control module 230 may be connected to the data obtaining module 210, the data processing module 220, the connection module 240, the storage module 250, and/or the terminal device 150. In some embodiments, the user control module 230 may receive instructions or operations from the terminal device 150. The terminal device 150 may include a smartphone, a tablet computer, a smart watch, a remote controller, a control panel, or the like, or any combination thereof. The user control module 230 may control the operations of one or more modules in the control system 100. In some embodiments, the user control module 230 may control the operating state of the connection module 240. For example, the user may open or close the connection between the connection module 240 and the subordinate controller 120 via the user control module 230. In some embodiments, the user control module 230 may control related parameters. The parameters may include time, content to be displayed, and an operating state of the control system 100. For example, the user may control the operating time and the operating temperature of the electric device 140, such as the air conditioner 141, via the user control module 230.

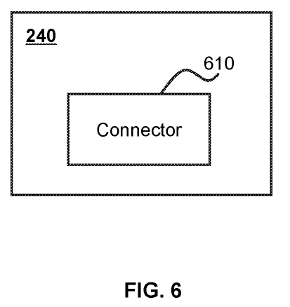

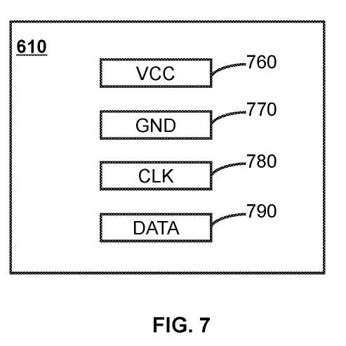

The connection module 240 may connect the master controller 110 and one or more subordinate controllers 120 via a connection. The connection may include one or more wired connections or one or more wireless connections. In some embodiments, the connection module 240 may provide electrical power to the subordinate controller 120 and/or obtain information from the subordinate controller 120. The information may be related to operating states of one or more of the load(s) 130, the electric device(s) 140, or the like. In some embodiments, the connection module 240 may include a connector for electrically connecting the master controller 110 and the one or more subordinate controllers 120. For more descriptions of the connector, FIGS. 6 and 7 may be made reference to. In some embodiments, the connection module 240 may include a control circuit. The control circuit may include a knife and a plurality of contacts. The knife and the plurality of contacts may be in a connection state or a disconnection state. In some embodiments, the control circuit may include a plurality of knives and a plurality of contacts. For example, the control circuit may include a multiway switch, such as a single pole double throw switch, a single pole six throw switch, a double pole double throw switch, or the like, or any combination thereof. In some embodiments, each control circuit may control one or more electric devices 140. In some embodiments, the control circuit may control the operating state of the electric device 140 by controlling the connection or disconnection state of the one or more contacts. For example, the master controller 110 may include two control circuits, such as a control circuit 1 and a control circuit 2. The control circuit 1 may include a double pole double throw switch. The control circuit 1 may control the on/off status of a refrigerator by controlling contact states of the double pole double throw switch (e.g., a knife 1, a knife 2) and four contacts (e.g., a contact 1, a contact 2, a contact 3, and a contact 4). The control circuit 2 may include a double pole double throw switch. The control circuit 2 may control an operating state of a light by controlling contact states of the two double pole double throw switches (e.g., a knife 3 and a knife 4) and four contacts (e.g., a contact 5, a contact 6, a contact 7, and a contact 8).

The storage module 250 may store information. The information may be received from the subordinate controller 120, the data obtaining module 210, the data processing module 220, the connection module 240, the terminal device 150, or the like, or any combination thereof. In some embodiments, the data obtaining module 210 may obtain the information from the subordinate controller 120 and transmit the obtained information to the storage module 250. In some embodiments, the information transmitted from the subordinate controller 120 to the master controller 110 may be obtained by another subordinate controller 120. For example, the subordinate controller 120-2 may obtain the information and transmit the obtained information to the subordinate controller 120-1. The subordinate controller 120-1 may transmit the information to the master controller 110.

The power module 260 may supply power to a device that consumes electrical power. The device may include the master controller 110, the subordinate controller 120, the electric device 140, or the like, or any combination thereof. The power module 260 may include an electrical power storage device. The electrical power storage device may be a disposable battery and/or a rechargeable battery. In some embodiments, the power module 260 may be powered by an external power supply device. The external power supply device may be a switched-mode power supply, an inverter power supply, an alternating-current (AC) stabilized power supply, a direct-current (DC) stabilized power supply, a DC/DC power supply, a communication power supply, a modular power supply, a variable frequency power supply, an uninterrupted power supply (UPS), an Entry-Level Power Supply Specification (EPS) emergency power supply, a purification power supply, a PC power supply, a rectification power supply, a custom power supply, an adapter power supply, a linear power supply, a voltage regulation power supply, a transformer power supply, or the like.

It should be noted that the above description of the master controller 110 is merely provided for illustration purposes, and not intended to limit the scope of the present disclosure. For persons having ordinary skills in the art, multiple variations and modifications may be made under the teachings of the present disclosure. Modules may be combined in various ways, or connected with other modules as sub-systems. However, those variations and modifications do not depart from the scope of the present disclosure. For example, the master controller 110 may not include the storage module 250. The master controller 110 may store data in the server 160.

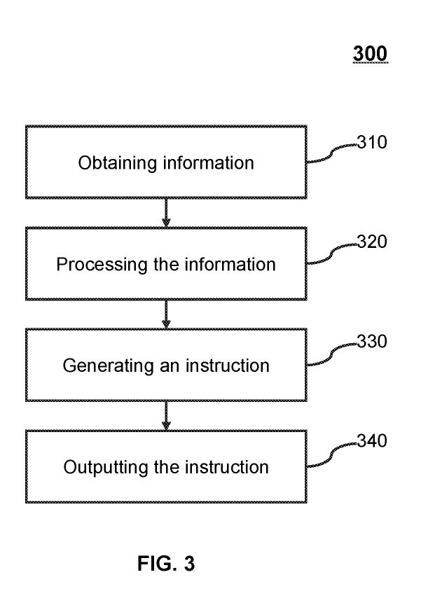

FIG. 3 is a flowchart of an exemplary process 300 for generating an instruction to control an operating state of an electric device 140 according to some embodiments of the present disclosure. Process 300 may be implemented by the control system 100. For example, process 300 may be implemented in the form of a set of instructions (e.g., an application program). The data processing module 220 may execute the set of instructions and perform steps in process 300 accordingly.

In step 310, the master controller 110 may obtain information. The information obtaining process may be implemented by the data obtaining module 210. In some embodiments, the information inputted by a user may be obtained. For example, the user may input an instruction via the user control module 230. In some embodiments, surrounding parameters, such as humidity, temperature, and other related information, may be obtained. For example, the information may be obtained by a sensor. The sensor may be or include an infrared sensor, a pressure sensor, a temperature sensor, a humidity sensor, a gas sensor, or the like. According to the operating mechanism, the sensor may be a resistive sensor, an inductive sensor, a capacitive sensor, an electric potential sensor, or the like. In some embodiments, a historical operating state or a real-time operating state of the electric device 140 may be obtained. The operating state may include, for example, the on/off status of a bedroom light, a real-time wind speed of the air conditioner 141, an operating temperature of a refrigerator, or the like. In some embodiments, the on/off status of a control circuit of the master controller 110 and/or the subordinate controller 120 may be obtained. In some embodiments, the information may be obtained by the subordinate controller 120 and transmitted to the master controller 110, or be obtained by the master controller 110.

In step 320, the master controller 110 may process the obtained information. In some embodiments, a data processing operation may include a data pre-processing operation, a digital-to-analog conversion, or the like, or any combination thereof. The data pre-processing operation may include a denoising operation, a Fourier transformation, a dark current processing, or the like, or any combination thereof. For example, the master controller 110 may perform the analog-to-digital signal conversion operation on the instruction information inputted by the user.

In step 330, the master controller 110 may generate an instruction based on the processed information. In some embodiments, the instruction generation process may be implemented by the data processing module 220. For example, the master controller 110 may generate the instruction based on the on/off status information of the electric device 140 and the connection status information of the contacts of the control circuit controlling the electric device 140. The master controller 110 may control the on/off status of the electric device 140 by controlling the connection or disconnection of the contacts of the control circuit.

In step 340, the master controller 110 may output the instruction. In some embodiments, the master controller 110 may output the instruction to the electric device 140, the subordinate controller 120, the control circuit, or the like. For example, the control circuit may execute the instruction output by the master controller 110 to control the operating state of the electric device 140.

It should be noted that the above description of the instruction generation process is merely provided for illustration purposes, and not intended to limit the scope of the present disclosure. For persons having ordinary skills in the art, multiple variations and modifications may be made under the teachings of the present disclosure. The order of steps in process 300 may be changed. However, those variations and modifications do not depart from the scope of the present disclosure. For example, one or more selections or processing conditions may be added between step 310 and step 340. As another example, the information obtained in step 310 may be stored and backed up. Similarly, the storage and backup step may be added between any two steps in process 300.

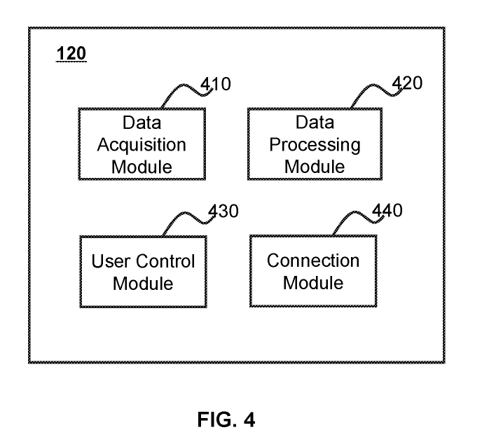

FIG. 4 is a schematic diagram of an exemplary subordinate controller 120 according to some embodiments of the present disclosure. The subordinate controller 120 may include a data acquisition module 410, a data processing module 420, a user control module 430, and a connection module 440.

The data acquisition module 410 may acquire data. The data may be related to real-time operating data of the load 130 and/or the electric device 140. The data may be related to environmental parameters of the surrounding environment. The environmental parameters may include humidity, temperature, light intensity, or the like, or any combination thereof. In some embodiments, the data acquisition module 410 may be connected to the data processing module 420, the data obtaining module 210, the storage module 250, the user control module 430, and/or the connection module 440. In some embodiments, the data acquisition module 410 may transmit the acquired data to one or more of the aforementioned modules. For example, the data acquisition module 410 may transmit the data to the data processing module 420. As another example, the data acquisition module 410 may transmit the acquired data to the connection module 240 via the connection module 440 and then to the data obtaining module 210. In some embodiments, the data obtaining module 210 may include a sensor. The sensor may be or include an infrared sensor, a pressure sensor, a temperature sensor, a humidity sensor, a gas sensor, or the like. According to the operating mechanism, the sensor may be a resistive sensor, an inductive sensor, a capacitive sensor, an electric potential sensor, or the like.

The data processing module 420 may process data. In some embodiments, the data processing module 420 may be connected to the data acquisition module 410, the user control module 430, and/or the connection module 440. For example, the data processing module 420 may process the data received from the data acquisition module 410 and transmit the processed data to the connection module 440. In some embodiments, the processed data may be transmitted to the data obtaining module 210 via the connection module 440 and the connection module 240. The data obtaining module 210 may further transmit the processed data to the data processing module 220. In some embodiments, the data processing module 220 may process the data acquired from the one or more modules and generate one or more instructions. For example, the data processing module 220 may process data received from the data obtaining module 210 to generate the one or more instructions. In some embodiments, the one or more instructions may be related to an operating state of the electric device 140 connected to the master controller 110. In some embodiments, the operating state may include the on/off status, an operating power, an operating time, and an operating temperature, or the like, of the electric device 140. For example, the instructions may include turning on/off the electric device 140, increasing/decreasing the operating power of the electric device 140, changing the operating mode of the electric device 140, or the like. In some embodiments, the data processing module 420 may process the data received from the data acquisition module 410 to generate the one or more instructions. The instructions may be related to the operating state of the load 130 connected to the data processing module 420. In some embodiments, the operating state may include the on/off status, an operating power, and an operating time of the load 130. For example, the instructions may include turning on/off the load 130, increasing/decreasing the operating power of the load 130, changing the operating mode of the load 130, or the like. In some embodiments, the data processing module 420 may perform a pre-processing operation on the received data. The pre-processing operation may include a dark current removing operation, a Fourier transformation operation, a noise removing operation, or the like.

The user control module 430 may be connected to the data acquisition module 410, the data processing module 420, the connection module 440, or the like, or any combination thereof. In some embodiments, the user may input an instruction via the user control module. In some embodiments, the instruction may be related to an operating state of the electric device 140 connected to the master controller 110. In some embodiments, the instruction may be related to an operating state of the load 130 connected to the subordinate controller 120. In some embodiments, the user control module 430 may transmit the instruction inputted by the user to the connection module 440 and transmit the instruction to the master controller 110 via the connection module 440 and the connection module 240. For example, the air conditioner 141 may be connected to the master controller 110, and the user may input the instruction via the user control module 430. The instruction may be, for example, turning on/off the air conditioner 141, increasing/decreasing the operating temperature of the air conditioner 141, or the like. In some embodiments, the instruction may be transmitted to the master controller 110 via the connection module 440 and the connection module 240. The master controller 110 may control the operating state of the air conditioner 141 according to the received instruction. As another example, the load 130 (e.g., a light) may be associated with the subordinate controller 120. The user may input the instruction via the user control module 430 (e.g., turning on the light).

The connection module 440 may connect the subordinate controller 120 and the master controller 110 via a connection. The connection may include one or more wired connections or one or more wireless connections. In some embodiments, the connection module 440 may obtain electrical power from the master controller 110 and/or transmit information to the master controller 110. The information may be related to the operating state of the load 130 and/or the electric device 140. In some embodiments, the connection module 440 may include a connector. The connector may electrically connect the subordinate controller 120 to one or more subordinate controllers 120. For more descriptions of the connector, FIGS. 6 and 7 may be made reference to. In some embodiments, the connection module 440 may receive information from the data acquisition module 410, the data obtaining module 210, the user control module 430, or the like, and transmit the received information to the connection module 240. For example, the connection module 440 may receive an instruction inputted by a user via the user control module 430. The instruction may be, for example, opening an electric light associated with the master controller 110. The instruction may be transmitted to the master controller 110 via the connection module 240. The master controller 110 may turn on the electric light according to the instruction. In some embodiments, the connection module 440 may include a control circuit. In some embodiments, the control circuit may include a knife and a plurality of contacts. The contacts and the knife may be in a connection or disconnection state. In some embodiments, the control circuit may include a plurality of knives and a plurality of contacts. For example, the control circuit may include a multiway switch. The multiway switch may be a single pole double throw switch, a single pole six throw switch, a double pole double throw switch, or the like, or any combination thereof. In some embodiments, each control circuit may control one or more electric devices 140. In some embodiments, the operating state of the electric device 140 may be controlled by controlling the connection or disconnection state of the contact and the knife of the control circuit. For example, the subordinate controller 120 may include two control circuits (e.g., a control circuit 3 and a control circuit 4). One of the two control circuits (e.g., the control circuit 3) may include a double pole double throw switch. The on/off status of the electric device 140 (e.g., a refrigerator) may be controlled by controlling the contact state of knives (e.g., a knife 5 and a knife 6) of the double pole double throw switch and the four contacts (e.g., a contact 9, a contact 10, a contact 11, and a contact 12). The other control circuit (e.g., the control circuit 4) may include a double pole double throw switch. The operating state of another electric device 140 (e.g., an electric light) may be controlled by controlling the contact state of the two knives (e.g., a knife 7 and a knife 8) and the four contacts (e.g., a contact 13, a contact 14, a contact 15 and a contact 16) of the double pole double throw switch.

It should be noted that the above description of the subordinate controller 120 is merely provided for illustration purposes, and not intended to limit the scope of the present disclosure. For persons having ordinary skills in the art, multiple variations and modifications may be made under the teachings of the present disclosure. Modules may be combined in various ways, or connected with other modules as sub-systems. However, those variations and modifications do not depart from the scope of the present disclosure.

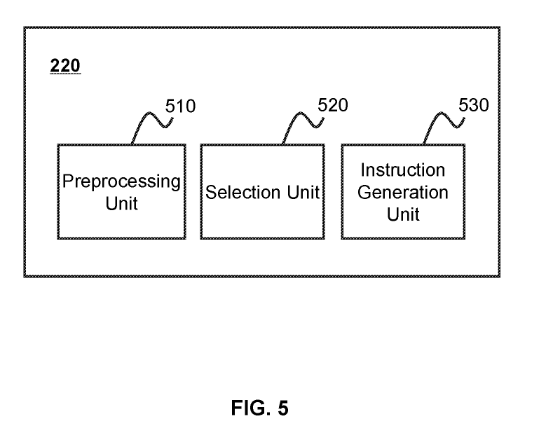

FIG. 5 is a schematic diagram of an exemplary data processing module 220 according to some embodiments of the present disclosure. As shown in FIG. 5, the data processing module 220 may include a preprocessing unit 510, a selection unit 520, and an instruction generation unit 530.

The preprocessing unit 510 may be connected to the data obtaining module 210, the data processing module 220, the connection module 240, the instruction generation unit 530, and/or the selection unit 520. In some embodiments, the preprocessing unit 510 may obtain data from one of the data obtaining module 210, the data processing module 220, the connection module 240, etc., and perform a filtering operation, a denoising operation, or the like, on the obtained data. The data may be an instruction inputted by the user, a real-time operating state or historical operating data of the electric device 140, a humidity or a temperature of the surrounding environment, or the like, or any combination thereof. In some embodiments, the preprocessing unit 510 may transmit the processed information to the selection unit 520 and/or the instruction generation unit 530.

The selection unit 520 may select one or more knives or contacts. The one or more knives may be the knife (or knives) of the master controller 110 and/or the subordinate controller 120. The one or more contacts may be the contact (or contacts) of the master controller 110 and/or the subordinate controller 120. In some embodiments, the selected knife or the selected contact may execute an instruction generated by the instruction generation unit 530. For example, the selection unit 520 may select a knife (e.g., a knife 1) of a control circuit of the master controller 110 and a contact (e.g., a contact 1) corresponding to the knife.

The instruction generation unit 530 may generate an instruction. The instruction may be related to the operating state of the master controller 110, the subordinate controller 120, and/or the electric device 140. For example, the instruction may be related to the on/off status of a control circuit of the master controller 110 and/or the subordinate controller 120. As another example, the instruction may be related to a connection or disconnection state of a knife of a control circuit of the master controller 110 and/or the subordinate controller 120, or a contact corresponding to the knife.

It should be noted that the above description of the data processing module 220 is merely provided for illustration purposes, and not intended to limit the scope of the present disclosure. For persons having ordinary skills in the art, multiple variations and modifications may be made under the teachings of the present disclosure. Modules may be combined in various ways, or connected with other modules as sub-systems. However, those variations and modifications do not depart from the scope of the present disclosure. For example, the function of the selection unit 520 may be integrated into the instruction generation unit 530.

FIG. 6 is a schematic diagram of an exemplary connection module according to some embodiments of the present disclosure. The connection module may be the connection module 240 of the master controller 110, or the connection module 440 of the subordinate controller 120. As shown in FIG. 6, the connection module may include one connector 610. In some embodiments, the connection module may include multiple connectors 610. For more descriptions of the connector 610, FIG. 7 may be made reference to.

FIG. 7 is a schematic diagram of an exemplary connector 610 according to some embodiments of the present disclosure. The connector 610 may be a connector 610 of the master controller 110, or a connector 610 of a subordinate controller 120. The connector 610 may include a VCC pin 760, a ground (GND) pin 770, a clock (CLK) pin 780, and a DATA pin 790. The master controller 110 may be connected to the subordinate controller 120 via the aforementioned pins. The subordinate controller 120 (e.g., the subordinate controller 120-1) may be connected to another subordinate controller 120 (e.g., the subordinate controller 120-2) via the aforementioned pins. In some embodiments, the connector 610 may include a plurality of (e.g., two or another number of) VCC pins 760, a plurality of GND pins 770, two CLK pins 780, and two DATA pins 790.

The VCC pin 760 may be connected to the anode of a power supply to maintain a high electric potential. In some embodiments, the VCC pin 760 of the master controller 110 may be connected to the VCC pin 760 of the subordinate controller 120. The master controller 110 may provide a high electric potential to the subordinate controller 120 via the aforementioned connection between the pins. In some embodiments, the VCC pin 760 of the subordinate controller 120 may be connected to the VCC pin 760 of the master controller 110 to obtain the high potential. The GND pin 770 may be connected to the ground to maintain a neutral potential.

In some embodiments, the CLK pin 780 of the master controller 110 may generate a clock signal that controls the connection between the master controller 110 and the subordinate controller 120. The CLK pin 780 of the subordinate controller 120 may receive the clock signal from the master controller 110. The DATA pin 790 of the master controller 110 may transmit information to the subordinate controller 120, or receive information from the subordinate controller 120. The DATA pin 790 of the subordinate controller 120 may transmit information to the master controller 110, or receive information (e.g., an instruction) from the master controller 110. In some embodiments, the pin of subordinate controller 120 may be connected to the pin of another subordinate controller 120 to receive or transmit information.

It should be noted that the above description of the control system 100 is merely provided for illustration purposes, and not intended to limit the scope of the present disclosure. For persons having ordinary skills in the art, multiple variations and modifications may be made under the teachings of the present disclosure. Modules may be combined in various ways, or connected with other modules as sub-systems. However, those variations and modifications do not depart from the scope of the present disclosure. For example, the connection module may include two VCC pins, one CLK pin, one GND pin, and two DATA pins.

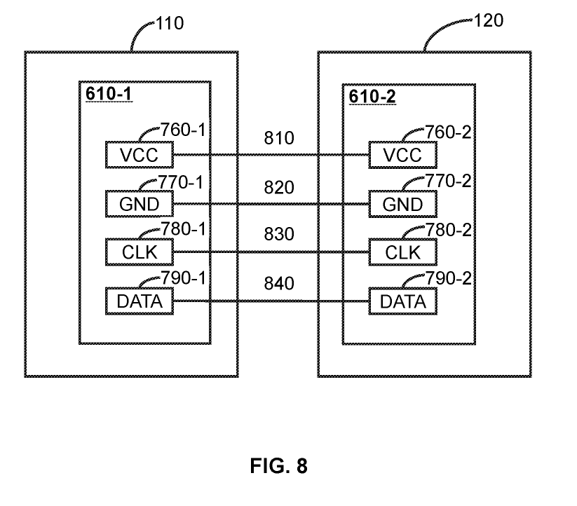

FIG. 8 is a schematic diagram of an exemplary connection between a master controller 110 and a subordinate controller 120 according to some embodiments of the present disclosure. The master controller 110 may be electrically connected to the subordinate controller 120. As shown in FIG. 8, a VCC pin 760-1 of the master controller 110 and a VCC pin 760-2 of the subordinate controller 120 may be connected via a wired circuit 810 such that the master controller 110 and the subordinate controller 120 may have the same electric potential. In some embodiments, the voltage may be generated and outputted by the power module 260 of the master controller 110. The GND pin 770-1 of the master controller 110 and the GND pin 770-2 of the subordinate controller 120 may be connected via a wired circuit 820. In some embodiments, the GND pin 770-1 of the master controller 110 may be connected to the ground such that the GND pin 770-1 of the master controller 110 and the GND pin 770-2 of the subordinate controller 120 may remain a neutral potential. For example, the wired circuit 810 and the wired circuit 820 may each be a electric wire. The CLK pin 780-1 of the master controller 110 and the CLK pin 780-2 of the subordinate controller 120 may be connected via a wired circuit 830. The subordinate controller 120 may receive a clock signal via the wired circuit 830. In some embodiments, the clock signal may be generated by the data processing unit of the master controller 110. In some embodiments, the subordinate controller 120 may perform an operation such as starting, restoring, resetting, and synchronizing with the master controller 110, based on the received clock signal. The DATA pin 790-1 of the master controller 110 and the DATA pin 790-2 of the subordinate controller 120 may be connected via a wired circuit 840. The wired circuit 840 may be for transmitting information. In some embodiments, the information may be transmitted from the master controller 110 to the subordinate controller 120 or from the subordinate controller 120 to the master controller 110. In some embodiments, the information transmitted from the subordinate controller 120 to the master controller 110 may be acquired by another subordinate controller 120. In some embodiments, the information may be related to an activity of a user. For example, the information may be an instruction inputted by the user via the subordinate controller 120. The instruction may be related to the operating state of the electric device 140 or the load 130. For example, the instruction may include turning on/off the electric device 140 such as a refrigerator, the air conditioner 141, an electric light, or the like.

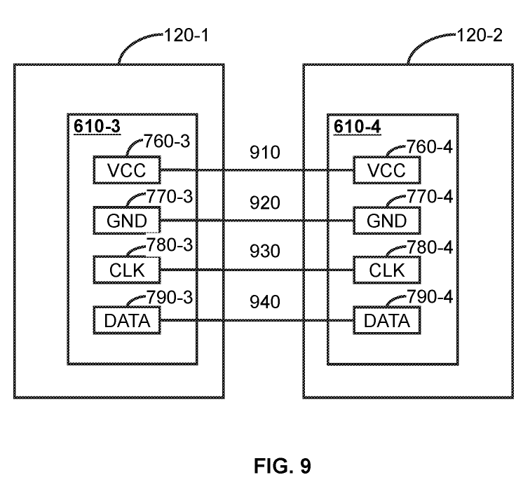

FIG. 9 is a schematic diagram of an exemplary connection between a connector of the subordinate controller 120-1 and a connector of the subordinate controller 120-2 according to some embodiments of the present disclosure. The subordinate controller 120-1 may be electrically connected to the subordinate controller 120-2. As shown in FIG. 9, the VCC pin 760-3 of the subordinate controller 120-1 and the VCC pin 760-4 of the subordinate controller 120-2 may be connected via a wired circuit 910. In some embodiments, the VCC pin 760-3 of the subordinate controller 120-1 or the VCC pin 760-4 of the subordinate controller 120-2 may be connected to the VCC pin of the master controller 110, so that the VCC pin 760-3 of the subordinate controller 120-1, the VCC pin 760-4 of the subordinate controller 120-2, and the pin of the master controller 110 may have the same voltage. In some embodiments, the voltage may be generated and outputted by the power module 260 of the master controller 110. The GND pin 770-3 of the subordinate controller 120-1 and the GND pin 770-4 of the subordinate controller 120-2 may be connected via a wired circuit 920. In some embodiments, the GND pin 770-3 of the subordinate controller 120-1 or the GND pin 770-4 of the subordinate controller 120-2 may be connected to the GND pin of the master controller 110, which is connected to the ground, so that the GND pin 770-3 of the subordinate controller 120-1 and the GND pin 770-4 of the subordinate controller 120-2 may have a neutral potential. The CLK pin 780-3 of the subordinate controller 120-1 and the CLK pin 780-4 of the subordinate controller 120-2 may be connected via a wired circuit 930. In some embodiments, the CLK pin 780-3 of the subordinate controller 120-1 may be connected to the CLK pin of the master controller 110 to receive a clock signal from the master controller 110, and transmit the received clock signal to the CLK pin 780-4 of the subordinate controller 120-2 via the wired circuit 930. In some embodiments, the clock signal may be generated by a data processing unit of the master controller 110. In some embodiments, the subordinate controller 120-1 and/or the subordinate controller 120-2 may perform operations such as starting, recovering, resetting, synchronizing, etc., with the master controller 110 based on the received clock signal. The DATA pin 790-3 of the subordinate controller 120-1 and the DATA pin 790-4 of the subordinate controller 120-2 may be connected via a wired circuit 940. The wired circuit 840 may transmit information. The information may be transmitted from the DATA pin 790-3 of the subordinate controller 120-1 to the DATA pin 790-4 of the subordinate controller 120-2, or from the DATA pin 790-4 of the subordinate controller 120-2 to the DATA pin 790-3 of the subordinate controller 120-1. In some embodiments, the DATA pin 790-3 of the subordinate controller 120-1 may be connected to the DATA pin of the master controller 110. For example, the DATA pin 790-3 of the subordinate controller 120-1 may receive information from the DATA pin 790-4 of the subordinate controller 120-2 and transmit the received information to the DATA pin of the master controller 110. As another example, the wired circuit 910, the wired circuit 910, the wired circuit 910, and/or the wired circuit 910 may each be a electric wire, an optical fiber, or the like.

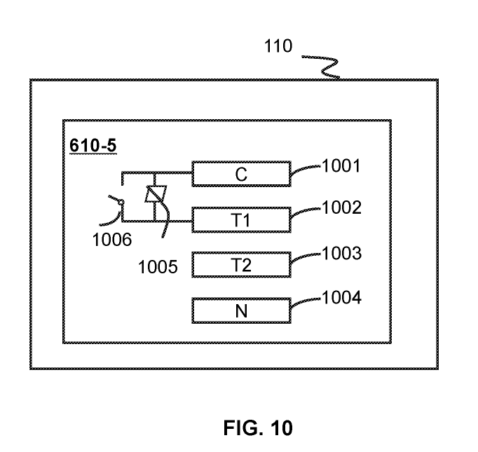

FIG. 10 is a schematic diagram of an exemplary connector 610-5 according to some embodiments of the present disclose. The connector 610-5 may be a connector 610-5 of the master controller 110 or a connector 610-5 of a subordinate controller 120 (e.g., the subordinate controller 120-1, the subordinate controller 120-2, the subordinate controller 120-3). The connector 610-5 may include a C pin 1001, a T1 pin 1002, a T2 pin 1003, an N pin 1004, a silicon-controlled switch 1005, and a relay switch 1006. The master controller 110 may be connected to the subordinate controller 120 (e.g., the subordinate controller 120-1, the subordinate controller 120-2, the subordinate controller 120-3) via the aforementioned pins. In some embodiments, the connector 610-5 may include a plurality of (e.g., two or another number of) C pins 1001, T1 pins 1002, T2 pins 1003, N pins 1004, and/or silicon-controlled switches 1005.

The C pin 1001 may be connected to the electric device 140 or a hot wire via a connection. The connection may include one or more wired connections or one or more wireless connections. The C pin 1001 of the master controller 110 may be connected to the electric device 140. For example, the electric device 140 may be an electric light, the air conditioner 141, the security device 144, the speaker 142, or the like, or any combination thereof. As another example, the C pin 1001 of the master controller 110 may be connected to the electric device 140 via an electrical connection (e.g., a electric wire). As still another example, the C-pin 1001 of the master controller 110 may be connected to the electric device 140 via a wireless network. The C-pin 1001 of the subordinate controller 120 may be connected to the hot wire to obtain electrical power. As a further example, the C pin 1001 of the subordinate controller 120 may be directly connected to the hot wire via the electrical connection (e.g., a electric wire).

The T1 pin 1002 may be connected to the master controller 110 and the subordinate controller 120 for power transfer. In some embodiments, the T1 pin 1002 of the master controller 110 may be connected to the T1 pin of the subordinate controller 120. For example, the T1 pin 1002 of the master controller 110 may be connected to the T1 pin 1002 of the subordinate controller 120 via the electrical connection (e.g., a electric wire). In some embodiments, the master controller 110 may transfer power (e.g., electrical power) to the subordinate controller 120 via the T1 pin 1002. For example, the master controller 110 may obtain power from the subordinate controller 120 via the T1 pin 1002. In some embodiments, the T1 pin 1002 may be connected to the C pin 1001. In some embodiments, the silicon-controlled switch 1005 may be connected between the T1 pin 1002 and the C pin 1001. The silicon-controlled switch 1005 may control an operating state (e.g., disconnected or closed) of the electric device 140, the master controller 110, and/or the subordinate controller 120. In some embodiments, the silicon-controlled switch 1005 may be connected in parallel with the relay switch 1006. The relay switch 1006 may be an electromagnetic relay device, a time relay device, a solid state relay device, a magnetic reed relay device, a light relay device, or the like, or any combination thereof. The relay switch 1006 may control an operating state of the silicon-controlled switch 1005. For example, when the relay switch 1006 is in a disconnection state, the silicon-controlled switch 1005 may be in an operating state to control the operating states of the electric device 140 and/or the switch (e.g., the subordinate controller 120 or the master controller 110). When the relay device is in the closed state, the silicon-controlled switch 1005 may be in a non-operating state, and the operating state of the device or the switch (e.g., the subordinate controller 120 or the master controller 110) may not be controlled. As another example, when the control system 100 is operating and the relay switch 1006 of the master controller 110 is in the disconnection state, the silicon-controlled switch 1005 of the master controller 110 may be in the operating state. When the control system 100 is operating and the relay switch 1006 of the subordinate controller 120 is in the closed state, the silicon-controlled switch 1005 of the subordinate controller 120 may be in a non-operating state. In some embodiments, the user may control the disconnected or closed state of the relay switch 1006 via the user control module 230. For example, when the control system 100 is being installed, the relay switch 1006 of the master controller 110 and the relay switch 1006 of the subordinate controller 120 may be in a disconnection state. When the control system 100 is in the operating state, the user may close the relay switch 1006 of the subordinate controller 120 via the user control module 230.

The T2 pin 1003 of the master controller 110 may be connected to the T2 pin 1003 of the subordinate controller 120 via a connection. In some embodiments, the connection may include one or more wired connections or one or more wireless connections. For example, the T2 pin 1003 of the master controller 110 may be connected to the T2 pin 1003 of the subordinate controller 120 via an electrical connection (e.g., a electric wire). In some embodiments, the T2 pin 1003 may be connected to the N pin 1004.

The N pin 1004 may be connected to a neutral wire. In some embodiments, the N pin 1004 may be directly connected to the neutral wire. For example, the N-pin 1004 of the master controller 110 may be connected to the neutral wire via the electrical connection (e.g., a electric wire). In some embodiments, the N pin 1004 of the master controller 110 may be connected to the N pin 1004 of the subordinate controller 120, and the N pin 1004 of the subordinate controller 120 may be connected to the neutral wire.

It should be noted that the above description of the connector 610-5 is merely provided for illustration purposes, and not intended to limit the scope of the present disclosure. For persons having ordinary skills in the art, multiple variations and modifications may be made under the teachings of the present disclosure. Modules may be combined in various ways, or connected with other modules as sub-systems. However, those variations and modifications do not depart from the scope of the present disclosure. For example, the connector 610-5 may further include one or more of the VCC pin 760, the GND pin 770, the CLK pin 780, and the DATA pin 790 of the connector 610 as described elsewhere in the present disclosure (e.g., FIG. 7 and descriptions thereof). As another example, the connector 610-5 of the subordinate controller 120 may include the silicon-controlled switch 1005 and the relay switch 1006. The connector 610-5 of the master controller 110 may include the silicon-controlled switch 1005 without the relay switch 1006. When the control system 100 is being installed, the relay switch 1006 of the subordinate controller 120 may be in the disconnection state. When the control system 100 is in the operating state, the user may close the relay switch 1006 of the subordinate controller 120 via the user control module 230. As still another example, the connector 601-5 may further include an indicator light, and when the C pin 1001 is connected to the hot wire, the corresponding indicator light may illuminate. In some embodiments, the user may open the relay switch of the connector corresponding to an illuminated indicator light via the control module 230.

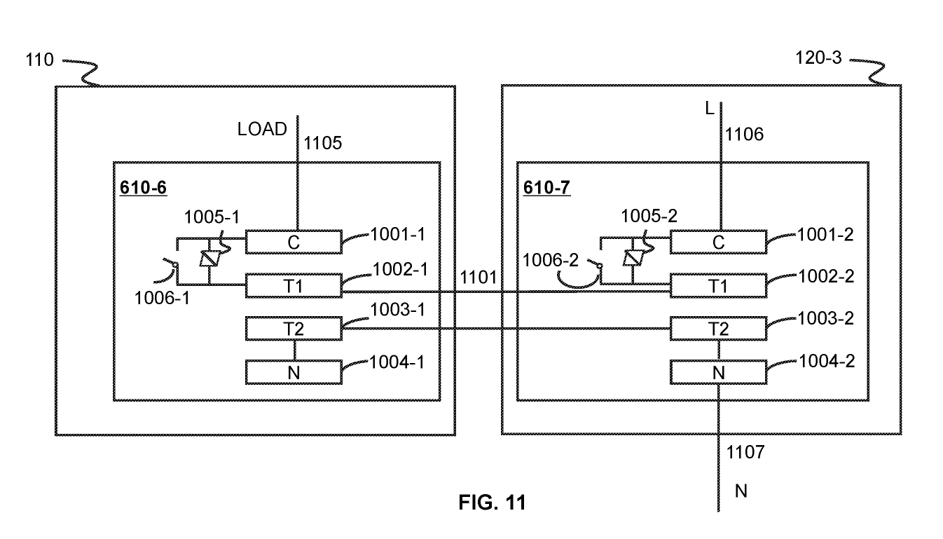

FIG. 11 is a schematic diagram of an exemplary connection between a master controller 110 and a subordinate controller 120-3 according to some embodiments of the present disclosure. The connector 610-6 of the master controller 110 may be electrically connected to the connector 610-7 of the subordinate controller 120-3. As shown in FIG. 10, the C pin 1001-1 of the master controller 110 may be connected to a load (e.g., the electric device 140) via a wired circuit 1105. The wired circuit may be a electric wire. The silicon-controlled switch 1005-1 of the master controller 110 and the relay switch 1006-1 of the master controller 110 may be connected between the C pin 1001-1 of the master controller 110 and the T1 pin 1002-1 of the master controller 110. The relay switch 1006-1 may be connected in parallel with the silicon-controlled switch 1005-1. In some embodiments, the silicon-controlled switch 1005-1 may control the operating state of the device and/or the master controller 110. For example, the device may be an electric light, and the silicon-controlled switch 1005-1 may control the operating power of the electric light. In some embodiments, the relay switch 1006-1 of the master controller 110 may control the operating state of the silicon-controlled switch 1005-1 of the master controller 110. As another example, when the control system 100 is operating, the relay switch 1006-1 of the master controller 110 may be in the disconnection state, and the silicon-controlled switch 1005-1 of the master controller 110 may be in the operating state. The T2 pin 1003-1 of the master controller 110 and the N pin 1004-1 of the master controller 110 may be connected via a wired circuit 1103. The T1 pin 1002-1 of the master controller 110 and the T1 pin 1002-2 of the subordinate controller 120-3 may be connected via a wired circuit 1101. The T2 pin 1003-1 of the master controller 110 and the T2 pin 1003-2 of the subordinate controller 120-3 may be connected via a wired circuit 1102. The C pin 1001-2 of the subordinate controller 120-3 may be connected to a hot wire via a wired circuit 1106. The silicon-controlled switch 1005-2 of the subordinate controller 120-3 and the relay switch 1006-2 of the subordinate controller 120-3 may be connected between the C pin 1001-2 of the subordinate controller 120-3 and the T1 pin 1002-2 of the subordinate controller 120-3. The relay switch 1006-2 may be connected in parallel with the silicon-controlled switch 1005-2. When the control system 100 is operating, the relay switch 1006-2 of the subordinate controller 120-3 may be in a closed state, and the silicon-controlled switch 1005-2 of the subordinate controller 120-3 may be in a non-operating state. The T2 pin 1003-2 of the subordinate controller 120-3 and the N pin 1004-2 of the subordinate controller 120-3 may be connected via a wired circuit 1104. The N-pin 1004-2 of the subordinate controller 120-3 may be connected to the neutral wire via a wired circuit 1107.

It should be noted that the above description of the connector 610-6 and the connector 610-7 are merely provided for illustration purposes, and not intended to limit the scope of the present disclosure. For persons having ordinary skills in the art, multiple variations and modifications may be made under the teachings of the present disclosure. Modules may be combined in various ways, or connected with other modules as sub-systems. However, those variations and modifications do not depart from the scope of the present disclosure. For example, the connector 610-7 of the subordinate controller 120-3 may include the silicon-controlled switch 1005-2 and the relay switch 1006-2. The connector 610-6 of the master controller 110 may include the silicon-controlled switch 1005-1 without the relay switch 1006-1. When the control system 100 is being installed, the relay switch 1006-2 of the subordinate controller 120 may be in the disconnection state. When the control system 100 is in the operating state, the user may close the relay switch 1006-2 of the subordinate controller 120 via the user control module 230. As another example, the connector 601-7 may further include an indicator light. When the C pin 1001-2 may be connected to the hot wire, the indicator light may be illuminated. In some embodiments, the user may open the relay switch 1006-2 of the connector 610-7 corresponding to the indicator light via the control module 230.

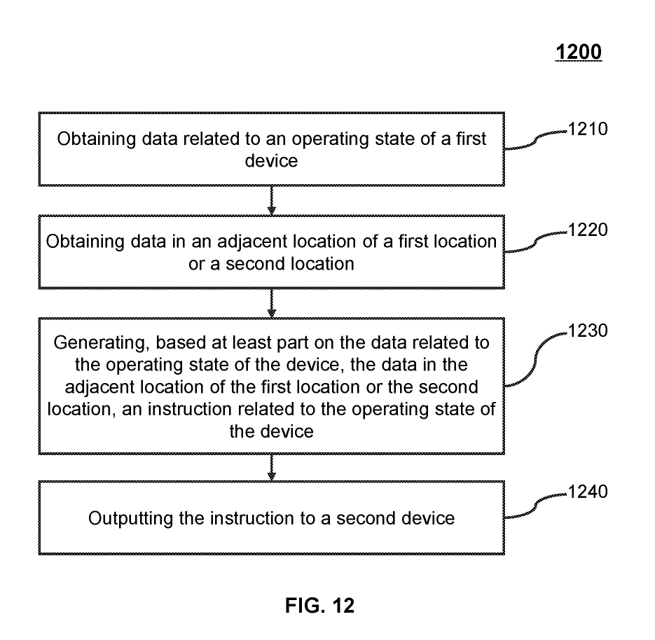

FIG. 12 is a flowchart of an exemplary process for generating an instruction for controlling an operating state of a device according to some embodiments of the present disclosure. Process 1200 may be implemented by the control system 100. For example, process 1200 may be implemented in the form of a set of instructions (e.g., an applications program). The data processing module 220 may execute the set of instructions and operate steps in process 1200 accordingly.

In step 1210, the data obtaining module 210 may obtain data related to an operating state of the electric device 140. The electric device 140 may be connected to the master controller 110. For example, the device may be an electric light, the air conditioner 141, the security device 144, the speaker 142, or the like, or any combination thereof. In some embodiments, the data obtaining module 210 may obtain the data related to the operating state of the electric device 140 via a sensor (e.g., a temperature sensor, a humidity sensor, a pressure sensor, a chemical sensor, or a motion sensor). In some embodiments, the data obtaining module 210 may obtain the data related to the operating state of the electric device 140 from the subordinate controller 120. For example, the data obtaining module 210 may obtain the on/off status of an electric light connected to the master controller 110 installed in a living room. As another example, the master controller 110 may control the on/off status of the electric light via a control circuit. The control circuit may include a double pole double throw switch. The double pole double throw switch may include two knives (e.g., a knife 1 and a knife 2) and four contacts (e.g., a contact 1, a contact 2, a contact 3, and a contact 4).

In step 1220, the data obtaining module 210 may obtain data in an adjacent location of a location. In some embodiments, the location may be where the master controller 110 is located. In some embodiments, the location may be where one or more subordinate controllers 120 are located. The adjacent location may be a location within a range (e.g., a diameter distance of 30 meters or other range) of the master controller 110 or the subordinate controller 120. In some embodiments, the data may be related to connection state of a knife (e.g., a knife 1) of the master controller 110 (or the subordinate controller 120) with a contact (e.g., a contact 1) corresponding to the knife. In some embodiments, the data may be related to environmental parameters of the environment of the adjacent location, such as humidity, temperature, or the like. In some embodiments, the data may be acquired in the adjacent location, for example, by a sensor installed in the adjacent location, such as an infrared sensor, a temperature sensor, a humidity sensor, a pressure sensor, a motion sensor, a gas sensor, or the like. For example, the master controller 110 may be mounted in a bedroom, and a sensor (e.g., a motion sensor) may be mounted adjacent to the location where the master controller 110 is (e.g., at ane entrance of a corridor within a diameter distance of 5 meters from the master controller 110). When the user is approaching the entrance of the corridor, a motion sensor may detect the proximity of the user and transmit the detected data to the data obtaining module 210 of the master controller 110.

In 1230, the data processing module 220 may generate one or more instructions based on the data related to the operating state of the electric device 140 and the data in the adjacent location of the location. In some embodiments, the data processing module 220 may generate the one or more instructions based on the operating state of the electric device 140, the operating state of a switch at the adjacent location of the location, and data obtained by the sensor installed at the adjacent location of the location. The switch may be the master controller 110 and/or the one or more subordinate controllers 120. For example, an electric light may be mounted in the living room, the master controller 110 may be mounted in the bedroom, and the electric light may be associated with the master controller 110. The motion sensor may be mounted adjacent to where the master controller 110 is located, for example, a corridor entrance. When the user approaches the motion sensor, the motion sensor may detect the proximity of the user and transmit information to the data processing module 220. The data processing module 220 may acquire an operating state (e.g., a closed state) of the electric light, and a connection state of a knife (e.g., the knife 1) of the master controller 110 with a contact (e.g., the contact 1) corresponding to the knife (e.g., the knife 1 and the contact 1 may be in the disconnection state), and generate an instruction to turn on the electric light. The instruction may be, for example, to connect the knife to the contact or to disconnect another knife and another contact (e.g., the knife 2 and the contact 3). As another example, an air conditioner may be installed in the bedroom, the master controller 110 may be installed at the entrance to the corridor, and an infrared sensor may be mounted adjacent to where the master controller is located. When the user approaches the infrared sensor, the infrared sensor may detect the proximity of the user and transmit the information to the data processing module 220. The data processing module may acquire an operating state (e.g., a real-time operating temperature) of the air conditioner, and a connection state (e.g., the knife 3 and the contact 5 may be in the disconnection state) of a knife (e.g., the knife 3) of the master controller 110 and a contact (e.g., the contact 5) corresponding to the knife, and generate an instruction to increase the operating temperature of the air conditioner. The instruction may be to connect the knife to the contact (e.g., the knife 3 and the contact 5), or to disconnect another knife and another contact (e.g., the knife 4 and the contact 7).

In 1240, the data processing module 220 may output the instruction to one or more devices. The device may be a multiway switch. For example, the multiway switch may be a single pole double throw switch, a double pole double throw switch, a single pole six throw switch, or the like. In some embodiments, the device may be connected to the master controller 110 or the subordinate controller 120. For example, the data processing module 220 may output the instruction for turning on the light to the double pole double throw switch, to connect a knife to a contact (e.g., the knife 1 and the contact 1), or to disconnect another knife and another contact (e.g., the knife 2 and the contact 3). As another example, the data processing module 220 may output the instruction to increase the operating temperature of the air conditioner to a double pole double throw switch, to connect a knife to a contact (e.g., the knife 3 and the contact 5), or to disconnect another knife and another contact (e.g., the knife 4 and the contact 7).

It should be noted that the above description of the process for generating an instruction is merely provided for illustration purposes, and not intended to limit the scope of the present disclosure. For persons having ordinary skills in the art, multiple variations and modifications may be made under the teachings of the present disclosure. The order of steps in process 1200 may be changed. However, those variations and modifications do not depart from the scope of the present disclosure. For example, one or more selections or processing conditions may be added between the data obtaining step 1210 and the instruction output step 1240. For example, the obtained data may be stored and backed up. Similarly, the storage and backup step may be added between any two steps in process 1200.

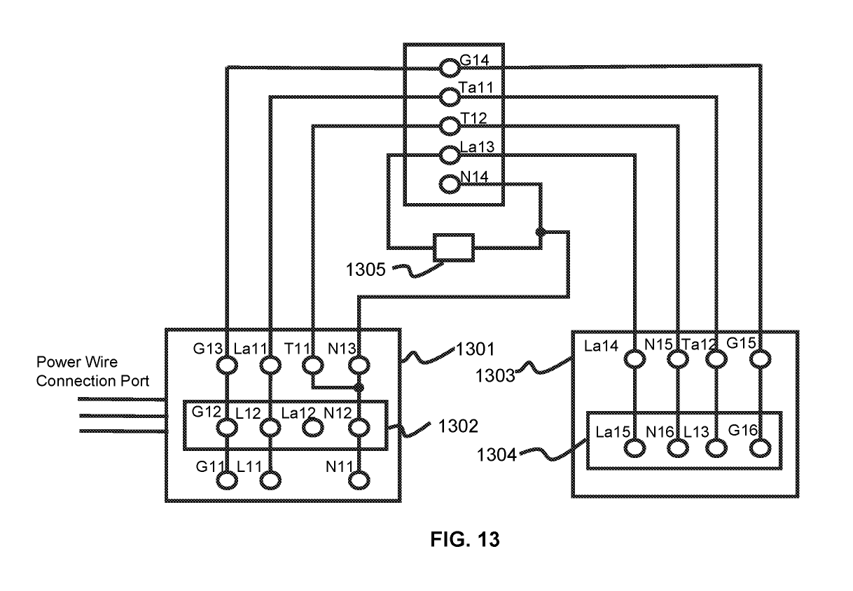

FIG. 13 is a schematic diagram of an exemplary connection pattern in the control system 100 according to some embodiments of the present disclosure. As shown in FIG. 13, the control system 100 may include a master controller 1302, a subordinate controller 1304, and a load junction box 1305. The master controller 1302 may include a single pole double throw switch mounted in a coaxial box 1301. The subordinate controller 1304 may include a single pole double throw switch mounted in a coaxial box 1303. In some embodiments, the master controller 1302 and the subordinate controller 1304 may include a connector (e.g., the connector 610 and/or the connector 610-5) disclosed in some embodiments of the present disclosure. As shown in FIG. 13, a connection point G11 may be connected to a connection point G12. The connection point G12 may be connected to a connection point G13. The connection point G13 may be connected to a connection point G14. The connection point G14 may be connected to a connection point G15. The connection point G15 may be connected to a connection point G16. A connection point L11 may be connected to a connection point L12. The connection point L12 may be connected to a connection point La11. The connection point La11 may be connected to a connection point Ta11. The connection point Ta11 may be connected to a connection point Ta12. The connection point Ta12 may be connected to a connection point L13. A connection point N11 may be connected to a connection point N12. The connection point N12 may be connected to a connection point N13 and a connection point T11. The connection point T11 may be connected to a connection point T12. The connection point T12 may be connected to a connection point N15. The connection point N15 may be connected to a connection point N16. The connection point N13 may be connected to a connection point N14 and the load junction box 1305. The load junction box 1305 may be connected to a connection point La13. The connection point La13 may be connected to a connection point La14. The connection point La14 may be connected to a connection point La15.

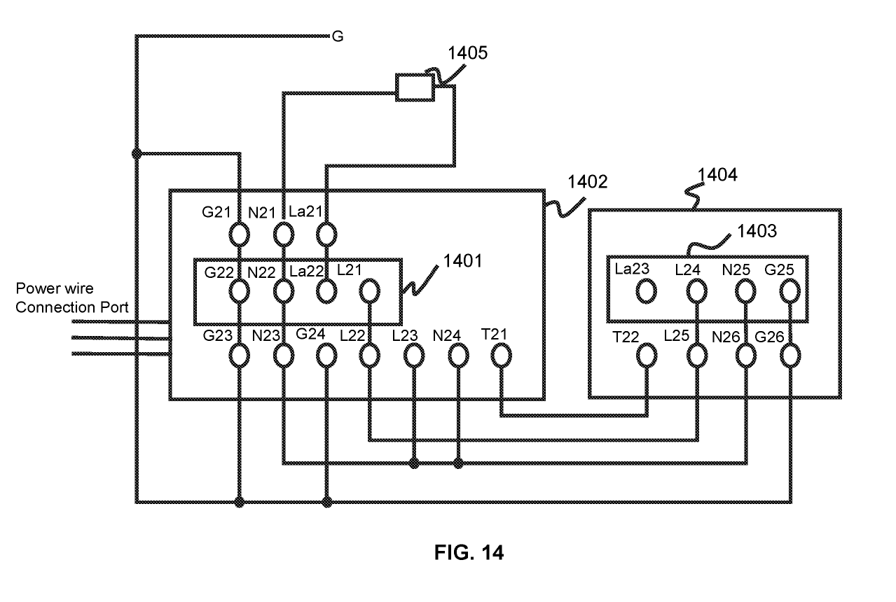

FIG. 14 is a schematic diagram of an exemplary connection pattern in a control system according to some embodiments of the present disclosure. As shown in FIG. 14, the control system 100 may include a master controller 1401, a subordinate controller 1403, and a load junction box 1405. The master controller 1401 may include a single pole double throw switch mounted in a coaxial box 1402. The subordinate controller 1403 may include a single pole double throw switch mounted in a coaxial box 1404. In some embodiments, the master controller 1401 and the subordinate controller 1403 may include a connector (e.g., the connector 610 and/or the connector 610-5) disclosed in some embodiments of the present disclosure. As shown in FIG. 14, one end of a connection point G21 may be grounded. The other end of the connection point G21 may be connected to a connection point G22. The connection point G22 may be connected to a connection point G23. One end of the connection point G23 may be connected to a connection point G26. The other end of the connection point G23 may be grounded. The connection point G26 may be connected to a connection point G25. A connection point N25 may be connected to a connection point N26. The connection point N26 may be connected to a connection point N23. The connection point N23 may be connected to a connection point N22. The connection point N22 may be connected to a connection point N21. The connection point La21 may be connected to a connection point La22. A connection point L21 may be connected to a connection point L22. The connection point L22 may be connected to a connection point L25. The connection point L25 may be connected to a connection point L24. A connection point T21 may be connected to a connection point T22. A connection point G24 may be connected to a connection point G23 and a connection point G26. A connection point L23 may be connected to the connection point N23 and the connection point N26. A connection point N24 may be connected to the connection point N23 and the connection point N26.

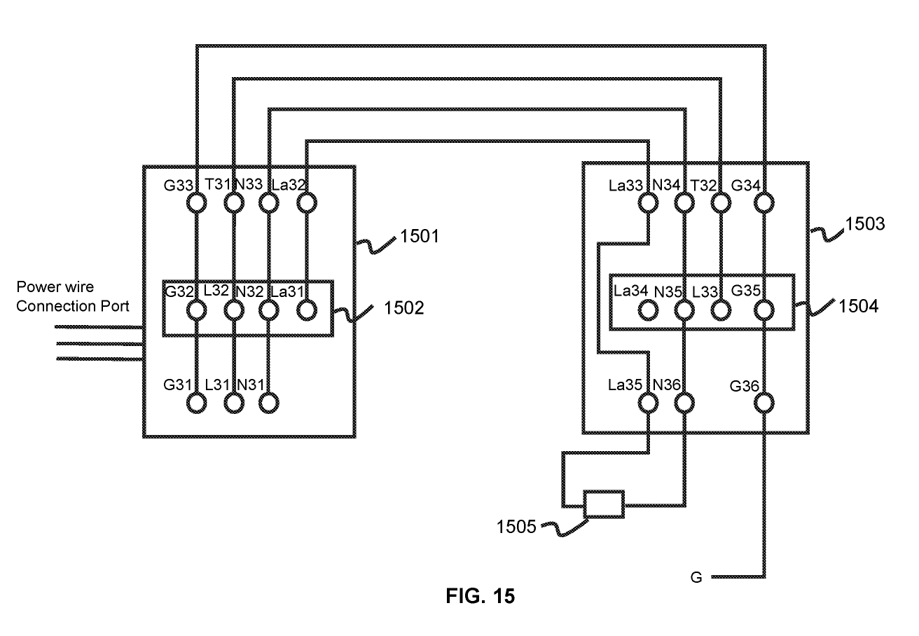

FIG. 15 is a schematic diagram of an exemplary connection pattern in a control system according to some embodiments of the present disclosure. As shown in FIG. 15, the control system 100 may include a master controller 1502, a subordinate controller 1504, and a load junction box 1505. The master controller 1502 may include a single pole double throw switch mounted in a coaxial box 1501. The subordinate controller 1504 may include a single pole double throw switch mounted in a coaxial box 1503. In some embodiments, the master controller 1502 and the subordinate controller 1504 may include a connector (e.g., the connector 610 and/or the connector 610-5) disclosed in some embodiments of the present disclosure. As shown in FIG. 15, a connection point G31 may be connected to a connection point G32. The connection point G32 may be connected to a connection point G33. The connection point G33 may be connected to a connection point G34. The connection point G34 may be connected to a connection point G35. The connection point G35 may be connected to a connection point G36. The connection point 36 may be grounded. A connection point L31 may be connected to a connection point L32. The connection point L32 may be connected to a connection point T31. The connection point T31 may be connected to a connection point T32. The connection point T32 may be connected to a connection point L33. A connection point N31 may be connected to a connection point N32. The connection point N32 may be connected to a connection point N33. The connection point N33 may be connected to a connection point N34. The connection point N34 may be connected to a connection point L35. The connection point N35 may be connected to a connection point N36. The connection point N36 may be connected to one end of the load junction box 1505. Another end of the load junction box 1505 may be connected to a connection point La35. The connection point La35 may be connected to a connection point La33. The connection point La33 may be connected to a connection point La32. The connection point La32 may be connected to the connection point La31.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber electric wire, RF, or the like, or any suitable combination of the foregoing.

Computer program code for carrying out operations for aspects of the present disclosure may be written in a combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2103, Perl, COBOL 2102, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, for example, an installation on an existing server or mobile device.

Similarly, it should be appreciated that in the foregoing description of embodiments of the present disclosure, various features are sometimes grouped in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practielectric wire.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1. A system, comprising:
a master controller, including a first input port and a first output port, the first input port is connected to the first output port, the first output port is connected to an electric device; and
a subordinate controller electrically connected to the master controller, including a second input port and a second output port, the second input port is connected to a hot wire; wherein
the master controller includes a first switch;
the subordinate controller includes a second switch and a third switch; and
the third switch controls an on/off status of the first switch and the second switch.

2. The system of claim 1, wherein the first switch or the second switch includes a thyristor.

3. The system of claim 2, wherein the thyristor includes a silicon-controlled switch.

4-5. (canceled)

6. The system of claim 1, wherein the third switch includes an electronic controller.

7. The system of claim 6, wherein the electronic controller includes a relay switch.

8. The system of claim 1, wherein the second switch and the third switch are connected in parallel between the second input port and the second output port.

9-11. (canceled)

12. The system of claim 1, wherein the first input port and the second output port are connected via at least one electric wire.

13. The system of claim 1, wherein the master controller includes a third port and a fourth port, and the third port is electrically connected to the fourth port.

14. The system of claim 13, wherein the subordinate controller includes a fifth port and a sixth port, and the fifth port is electrically connected to the sixth port.

15. The system of claim 14, wherein the third port is connected to the fifth port via an electric wire.

16. The system of claim 15, wherein at least one of the fourth port or the sixth port is connected to a neutral wire.

17. A system, comprising:
a master switch placed in a first location; and
at least one subordinate switch placed in a second location; wherein:
the at least one subordinate switch is connected to the master switch, and configured to obtain electrical power from the master switch;
the master switch is configured to:
obtain first data related to an operating state of an electric device;
obtain second data of a first sensor in an adjacent location of the first location or the second location; and
generate, based at least in part on the first data and the second data, an instruction related to the operating state of the electric device.

18-19. (canceled)

20. The system of claim 17, wherein the master switch includes a single pole double throw switch or a double pole double throw switch.

21. The system of claim 17, wherein the subordinate switch includes a single pole double throw switch or a double pole double throw switch.

22. The system of claim 17, further comprising: a connector, wherein the subordinate switch obtains electrical power from the master switch via the connector.

23. The system of claim 22, wherein the master switch is configured to acquire data related to the operating state of the electric device from the subordinate switch via the connector.

24. The system of claim 17, wherein the data related to the operating state of the electric device is obtained from a second sensor or the subordinate switch.

25. The system of claim 24, wherein the second sensor includes a temperature sensor, a humidity sensor, a pressure sensor, a chemical sensor, or a motion sensor.

26. The system of claim 24, wherein the second sensor is connected to the master switch or the subordinate switch.

27. A method, comprising:
obtaining first data related to an operating state of an electric device;
obtaining second data of a sensor; and
generating, based at least in part on the first data and the second data, an instruction related to the operating state of the electric device.

28. The method of claim 27, further comprising:
outputting the instruction to the electric device.
